(19) United States
(12) Patent Application Publication
(10) Pub. No.: US 2013/0062946 A1
(43) Pub. Date: Mar. 14, 2013

(54) HIERARCHICAL BALANCING SYSTEM

(71) Applicant: Robert R. Ferber, JR., Woodside, CA (US)

(72) Inventor: Robert R. Ferber, JR., Woodside, CA (US)

(73) Assignee: ELECTRONVAULT, INC., Woodside, CA (US)

(21) Appl. No.: 13/232,857

(22) Filed: Sep. 14, 2011

(51) Int. Cl. H02J 1/00

(52) U.S. Cl. 307/43

(57) ABSTRACT

An example hierarchical balancing system is described that performs balancing amongst power packs comprising an arrangement of power cells, while the power packs separately perform cell-level balancing. A power pack impedance balancer may be implemented for power pack balancing using changes in impedance. An example apparatus may include a rail capacitor that is switchably connected to a first capacitor and switchably connected to a second capacitor. The first capacitor may also be switchably connected to a first power pack and the second capacitor may also switchably connected to a second power pack. Via controllable switches, the first and second capacitors may shuttle energy between the power packs through the rail capacitor. Additional and related methods and apparatuses are also provided.

### TECHNICAL FIELD

Embodiments of the present invention relate generally to energy systems, and, more particularly, balancing and monitoring energy levels in a storage or generation system.

### BACKGROUND

Power storage and generation technologies are rapidly evolving as consumers increase their demand for energy solutions that are both convenient and environmentally-friendly. Energy systems, which may be, for example, energy storage systems and energy generation systems, are more frequently being utilized in high power demand applications. To support these needs, some solutions combine any number of smaller power packs (e.g., arrangements of power cells) to construct a larger power system that can support the power requirements. For a variety of reasons, imbalances between the power packs can occur, resulting in diminished performance of the energy system.

### BRIEF SUMMARY

Example embodiments of the present invention include methods and apparatuses for performing impedance balancing across a number of power packs or parallel groups of power packs in an energy system, such as, for example, an energy storage system or an energy generation system. Each power pack may comprise an arrangement of power cells and a cell-level balancer that balances charge between the parallel groups of cells in the power pack. Balancing or the cell level as well as at the power pack level can thereby form a hierarchal balancer system, where the balancing is independently performed at different levels of the energy system (e.g., at the cell level within the power pack and separately at the power pack level). In some example embodiments, capacitors can be utilized to shuttle energy between power packs of an energy system to balance the energy stored in the power packs or parallel groups of power packs. Capacitors associated with each power pack or parallel group of power packs may be configured to operate as flying capacitors to shuttle charge to and from a rail capacitor. The rail capacitor can be implemented to shuttle charge between flying capacitors and ultimately between power packs for balancing. According to some example embodiments, the implementation of the flying capacitors and the rail capacitor form a power pack impedance balancer, which may be a component of an energy system implementing a hierarchical balancer apparatus. The balancer apparatus may be a sensorless device, because the switching performed to shuttle charge via the capacitors is not impacted by power pack voltage or resistance spreads, Ohmic sag or boost of the cells, or the like. The power pack impedance balancer can operate regardless of the loading condition of the energy system (e.g., under a heavy load, under a light load, or under no load). In addition, the voltage of the rail capacitor may also be monitored to determine an aggregate status of the energy system.

### BRIEF DESCRIPTION OF THE DRAWING(S)

Having thus described the invention in general terms, reference will now be made to the accompanying drawings, which are not necessarily drawn to scale, and wherein:

FIG. 1 illustrates a block diagram of an example energy system with a power pack impedance balancer connected to two power packs that each have cell-level balancers according to various example embodiments;

FIG. 2 illustrates a block diagram of an example energy system with a power pack impedance balancer connected to more complex arrangement of power packs that each have cell-level balancers according to various example embodiments;

FIG. 3 illustrates an example power pack impedance balancer connected to two power cells according to various example embodiments;

FIG. 4 illustrates an example method for performing power pack balancing in a hierarchical balancing system according to various example embodiments;

FIG. 5 is an illustration of an example electrical configuration of power cells in a power pack according to various example embodiments;

FIG. 6 illustrates another example power pack impedance balancer according to various example embodiments;

FIG. 7 is a graph of control signal waveforms according to various example embodiments;

FIG. 8 is a graph of charging a flying capacitor and a rail capacitor according to various example embodiments;

FIG. 9 is a graph of an alternative control signal waveform according to various example embodiments; and

FIG. 10 illustrates an example energy system monitor connected as a component of a power pack impedance balancer according to various example embodiments.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Like reference numerals refer to like elements throughout.

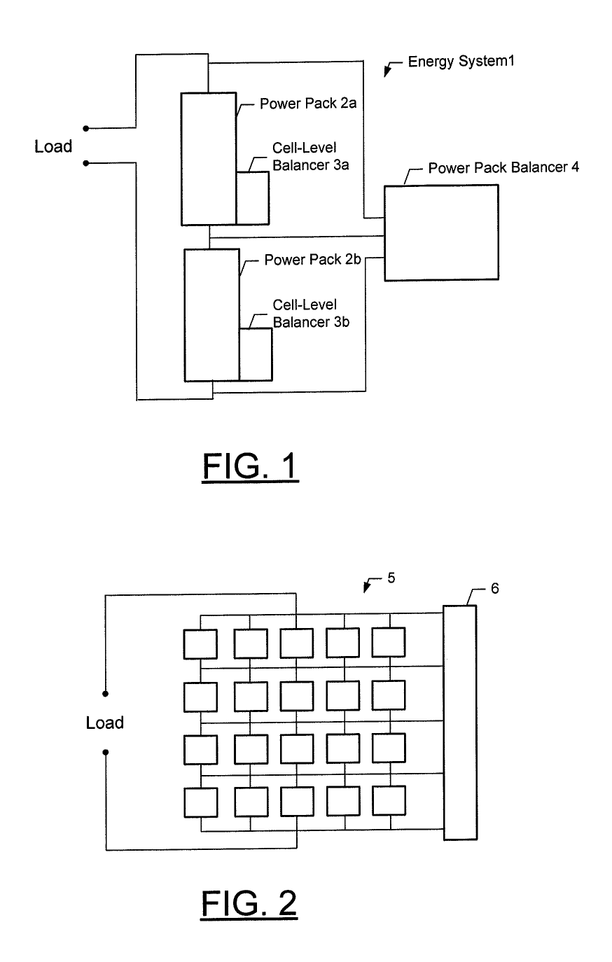

FIG. 1 illustrates an energy system 1 that is configured to supply energy to a load at its terminals. The energy system 1 may be comprised of any number of power packs (e.g., power packs 2a and 2b) and a power pack balancer 4. According to some example embodiments, the energy system 1 may be configured to support systems and loads having high-power demands. For example, the energy system 1 may be configured for connection to the utility power grid or other high-voltage power systems. In this regard, for example, the energy system 1 may be employed to perform peak shaving, supply backup power, and the like. In some instances, the energy system 1 may be configured for use in powering large vehicles (e.g., trucks, construction equipment, mass transit buses, watercraft, or the like).

According to various example embodiments, the number and connection arrangement of the power packs of the energy system 1 may be selected to support particular loads. Each power pack may have voltage and current output characteristics, and, in consideration of these characteristics, an energy system may be constructed that has desired output characteristics, for example, to support high-power applications. As such, power packs may be connected in various series and parallel connections to construct an energy system that has desired output characteristics.

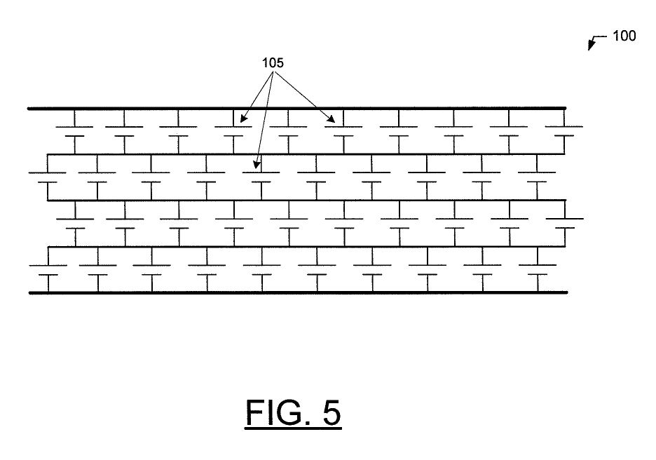

Each power pack 2 may include an arrangement of power cells that may be connected in any number of series and parallel configurations to achieve desired voltage and amperage output capabilities. According to some example embodiments, a power pack includes at least two parallel connected groups of power cells. FIG. 5 illustrates one example of an electrical configuration 100 of power cells 105 that can be used within a power pack of an energy system. A power cell may be any type of apparatus that outputs or sinks power. According to various example embodiments, power cells within a power pack may have any common voltage or chemistry. Power cells can include, for example, electrochemical or electrostatic cells, which may include batteries, such as lithium-ion, lead-acid, and metal-air batteries, capacitors (e.g., ultracapacitors and supercapacitors), fuel cells, photovoltaic cells, Peltier junction devices, piezoelectric cells, thermopile devices, solid state conversion cells, other hybrids of electrochemical and electrostatic cells, or the like, and combinations thereof.

According to some example embodiments, each power pack 2 may be housed in a respective enclosure or housing, and may be a unitized component of the energy system 1. In this regard, a power pack 2, which may include its cell-level balancer, may be a replaceable sub-component of the energy system 1. As such, the power packs may be self-contained modular components that can be used individually or combination with other power packs, depending on the desired outputs. Moreover, the unitary nature of the power packs 2 provides for vast energy system design flexibility, and a variety of energy output requirements can be realized using various numbers and electrical arrangements of the power packs.

The operation and characteristics of a power pack may be a reflection of the operation and characteristics of the power cells within the power pack. Power cells can be described as having a particular state of charge. In the aggregate, the state of charge of the cells in a power pack may be indicative of the state of charge of the power pack. The state of charge can be defined as a ratio of remaining energy capacity to the energy capacity available in a fully charged state for a power cell. The same can be said for the state of charge of a power pack, although relative to the energy capacity available in a fully charged state for a power pack. The state of charge for a power cell or a power pack changes when, for example, placed under a load or when being recharged.

Various example embodiments described herein operate to balance the state of charge through impedance balancing. In the case of power cells that are generative instead of storage, such as solar cells or Peltier junction devices, there is no state of charge. Instead, these power generative cells have a power output level that in some way resembles a state of charge, in that it can be defined as the ratio of the instantaneous output power to the maximum possible (or maximum rated, as appropriate) output power. “Power output level” as just defined can be treated as lexically interchangeable with “state of charge”, as appropriate to the type of power cells in question.

For a variety of reasons, cells, and therefore power packs, within an energy system may operate differently. Due to various factors including age, exposure to high temperatures, manufacturing flaws, or the like, a power cell may not be able to store and deliver the same amount of energy as other cells within a power system. Often, the changes that occur within a cell that occur as a result of, for example, aging, cause the internal impedance and energy storage capability or power production capability of the cells to change. These differences in impedance, which can be temperature dependent, can cause some cells to output more power than others thereby generating hotspots within the power pack, which can be detrimental to cell life and lead to increased imbalance between the cells of a power pack. A power pack that has more than one parallel group of power cells in series can display an imbalance as a difference in each parallel group in the series string to sink or source current, which can result in a constriction in the current path, possibly leading to elements of the lowest current capability parallel group to be driven over their actual instantaneous current capabilities (or outside of their voltage normal operating limits) while all other elements of the system are within their normal operating limits. Further, if a cell becomes completely discharged, while others continue to drive the load, the discharged cell may operate unpredictably and can, for example, become an open circuit, a short circuit, change polarity (which can result in the cell being destroyed), or the like. Such problems can detrimentally effect the overall operation of a power pack and shorten the life and current capacity of some or all of the cells within the power pack. Balancing between the cells within the power pack can therefore limit these detrimental effects.

Different applications for power packs comprising a number of power cells may require different voltages and current capacities, thereby requiring different electrical configurations of power cells. The voltage and current capacity of a power pack may be determined by the manner in which the power cells of the system are electrically connected together. In this regard, power cells may be connected as a series of parallel groups. The example electrical configuration 100 is a 4s10p configuration, which indicates that 4 series connected parallel groups of 10 power cells make up the configuration. As another example, a power pack may be designed that outputs 400 volts, using approximately 100 series connected parallel groups of cells.

For improved operation, a power pack may include, or be connected to, a cell-level balancer (e.g., cell-level balancers 3a and 3b). In this regard, a cell-level balancer may be configured to balance the charge differences of individual power cells of the battery pack or the charge differences of parallel groups of power cells within the power pack. In some example embodiments, a cell-level balancer may be one that balances charge by operating with respect to the terminals of a power cell or the terminal nodes of a parallel connected group of power cells. Various techniques may be used to perform cell-level balancing including, for example, impedance balancers that shuttle charge between cells (rather than power packs) using flying capacitors and a rail capacitor as described herein, bleed circuitry that bleeds down the charge on relatively highly charged cells via the switching of bleed resistors across cells to obtain a balance, or any other known technique for balancing power cells within a power pack.

As such, the energy system 1 may be configured to employ a hierarchical balancing technique by also performing balancing at the power pack level. In addition to performing cell-level balancing within each power pack, the energy system 1 may be configured to perform power pack-level balancing between parallel groups of power packs within the energy system 1. In this regard, power pack balancer 4 may be configured to perform impedance balancing between power pack 2a and power pack 2b of FIG. 1. As further described below, the power pack balancer 4 may be configured to shuttle charge between power pack 2a and power pack 2b to balance the charge between the power packs. At the same, according to some example embodiments, the cell-level balancers of the power packs may be performing balancing at the cell level, which may be performed independent from the balancing that is being performed at the power pack level. In this regard, the cell-level balancing and the power pack-level balancing may be performed separately and independently and control of the power pack-level balancing need not be aware of balancing control at the cell-level.

As such, a hierarchical balancing technique may be implemented where balancing is being performed at different levels of the energy system 1. One of skill in the art would appreciate that the hierarchical balancing that is being performed need not be limited to two levels. Rather, any number of levels of balancing may be implemented by creating groupings of power packs that can be balanced.

It is also appreciated that FIG. 1 illustrates a relatively simple architecture for performing power pack balancing as described herein. FIG. 2 therefore illustrates a more complex energy system 5 that includes four parallel sets of power packs (square boxes) with five power packs in each parallel group. The same techniques described for balancing the power packs 2a and 2b by power pack balancer 4, as described herein, can be scaled and applied to the balancing of the four parallel groups of power packs by the power pack balancer 6 of FIG. 2, where each of the power packs within FIG. 2 includes a respective cell-level balancer (not depicted).

According to various example embodiments, capacitors that are switchably connected in parallel with the power packs or parallel groups of power packs can be utilized to perform impedance balancing without changing the electrical configuration of the energy system. To implement power pack balancing with respect to differences in impedance between the power packs, capacitors may be utilized to shuttle charge or energy between the power pack or parallel groups of power packs. The charge can be shuttled from power packs or parallel groups that have more charge or which are sinking or sourcing more current, to power packs or parallel groups that have less charge or which are sinking or sourcing less current. In this manner, balancing between the power packs can be achieved. By shuttling charge between the power packs, the operation of the power packs can be normalized. Further, the shuttling of charge reallocates the energy distribution within the energy system without creating substantial increases in heat generation. Since the impedance of the power packs can be temperature dependent, by limiting the amount of heat generated through power pack balancing, the need to perform further balancing can also be reduced because heat is not introduced that continues to cause changes to the impedance of the power packs. According to various example embodiments, the capacitors can be used to balance the impedance of the power packs and shuttle charge or energy, while the energy system is being charged, while the energy system is supplying power to a load or sinking power from a source, or while an energy system is under no load. In this regard, example embodiments can be implemented to perform balancing during, for example, charging of the power packs regardless of whether a parallel or series charging scheme is utilized. Further, impedance balancing according to various example embodiments can be performed continuously, regardless of the load or charge conditions of the energy system. In some example embodiments, impedance balancing may be performed between entire energy systems, which may comprise a number of series connected parallel groups of power packs.

Various example embodiments of the present invention utilize capacitors or other charge storage devices to shuttle energy between power packs of an energy system to balance the charge stored in, or current generated by or sunk into the power packs by balancing the impedance. This balancing of the power packs is performed while each respective power pack is also performing cell-level balancing within the power packs. The cell-level balancing may be performed independent of the power pack level balancing. The simultaneous nature of the different levels of balancing within the energy system can result in improved overall operation and uniform usage between power packs. Through the use of capacitors that parallel the terminals of power pack or parallel a group of power packs, the power packs or parallel groups of power packs can be thought of as being connected in parallel during a balancing operation to bring the two cells or parallel groups of cells to a common impedance. However, through the use of switchably connected capacitors, the cells of parallel groups of power packs are not actually connected in parallel during balancing. As a result, charge that flows from one power pack to the capacitor can be delivered to another power pack. The capacitor can therefore be used to either provide charge to a power pack at a lower potential or receive charge from a power pack having a higher potential. Based on this concept, a charged or discharged capacitor can, through the use of switches, move charge from a first power pack through a rail capacitor to another power pack to perform a balancing operation. Operation in this manner can, according to some example embodiments, provide for application flexibility because power packs having any type of cell chemistry and any rated voltage may be balanced.

Additionally, with respect to charging, due to the shuttling of charge from a highly charged power pack or parallel group to a lower charged power pack or parallel group, according to some example embodiments, power pack chargers may be connected to, for example, a single power pack or a single parallel group. Via impedance balancing through capacitors, as described herein, charge from the power pack or parallel group that is being charged may be redistributed throughout the power packs of an energy system.

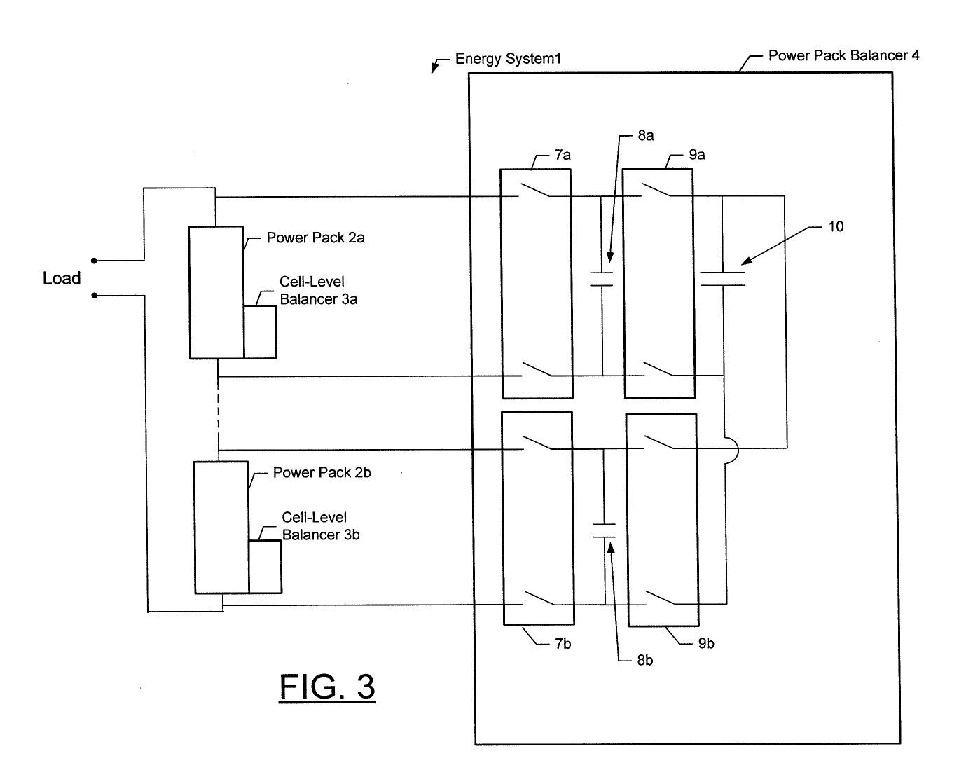

In view of the foregoing, FIG. 3 illustrates the energy system 1, with additional detail of one example embodiment of the power pack balancer 4. The power packer balancer 4 may be configured to operate as an impedance balancer to balance charge between power pack 2a and power pack 2b. As mentioned above, the power pack balancer 4 is described with respect to balancing between the two power packs 2a and 2b, but it is contemplated that the power pack balancer 4 may be scaled up, by adding flying capacitors, switches, and circuitry to drive the switches, to balance any number of power packs or parallel groups of power packs. The power pack balancer 4 may include flying capacitors 8a and 8b, a rail capacitor 10, and switch sets 7a, 9a, 7b, and 9b. Flying capacitors 8a and 8b may be referred to as “flying” as a result of being switchably connected either to a respective power pack 2a, 2b or the rail capacitor 10 to shuttle energy between the respective power pack 2a, 2b and the rail capacitor 10. In some example embodiments, the charge carrying capacity of the flying capacitors may be selected in consideration of the switching characteristics (e.g., the switching speed or the “switch-on” period) for the flying capacitors. In this regard, a relationship between the capacitance of the flying capacitor C_{fc}, the switch-on time t, and the switch-on state resistance Rₒₙ may approximately be Y*Rₒₙ*C_{fc}=t, where Y is typically between 3 and 5. For example, for switches having an switch-on (or on-channel) resistance of 0.01 Ohm and a switch on-time of 1/20,000 second, the flying capacitor may be sized to roughly 1000 microfarads. These relationships may be exemplary of the type that may be considered. However, larger or smaller sized flying capacitors may be used. Larger sized flying capacitors may diminish returns, while smaller sized capacitors may not permit the full current capacity of the switches to be utilized.

The rail capacitor 10 may be referred to as such, because the rail capacitor 10 can be switchably connected to each of the flying capacitors 8a, 8b. According to some example embodiments, the rail capacitor can be sized to have a larger charge carrying capacity than the flying capacitors. For example, if the flying capacitors are 100 microfarads, the rail capacitor may be 1000 microfarads. According to some example embodiments, the relationship between the sizing of the rail capacitor and the sizing of the flying capacitors may be proportional to the series power pack count for the energy system (i.e., the number of power packs or parallel groups of power packs that are connected in series in the energy system). More specifically, for a given sizing C_{fc} for the flying capacitor, the sizing for the rail capacitor may be C_{rc}=C_{fc}*S, where S is the series power pack count for the energy system. Larger or smaller size values for the rail capacitor may also be selected. Larger sized rail capacitors may provide more stable voltage measurements, if the rail is being monitored for overall instantaneous virtual cell voltage.

The switch sets 7a, 9a, 9b, and 7b may be any type of devices that can be controlled, via receipt of a control signal, to generate or break an electrical connection. According to some example embodiments, each of switch sets 7a, 9a, 9b and 7b can be configured to operate as a two switch set where each of the switches operate substantially in unison to generate or break electrical connections. In this regard, the switch sets 7a, 9a, 9b, and 7b may be configured to operate as double-pole, single throw switches. In some example embodiments, however, the switches in a switch set may be separately controlled. The switches may be selected to be able to support switch of current on the order of (1/duty cycle)*single power pack current. According to some example embodiments, each switch within a switch set may be embodied as a field-effect transistor that is controlled via a control signal to a gate terminal of the field-effect transistor. Further, according to some example embodiments, the switch sets 7a, 9a, 9b and 7b may be selected for high energy switching, and therefore, for example, the switches may be embodied as thyratrons, silicon controlled rectifiers (SCRs), or other high-power controllable switching.

Referring again to the power pack balancer 4, switch set 7a is connected such that when switch set 7a is closed (i.e., generating an electrical connection), terminals of the flying capacitor 8a are electrically connected across the terminals of the power pack 2a, and when the switch set 7a is open (i.e., breaking an electrical connection), the flying capacitor 8a is not connected to the power pack 2a and is electrically isolated from power pack 2a. Switch set 9a is connected such that when switch set 9a is closed, terminals of the flying capacitor 8a are electrically connected across the terminals of the rail capacitor 10, and when the switch set 9a is open, the flying capacitor 8a is not electrically connected to the rail capacitor 10 and is electrically isolated from rail capacitor 10. Similarly, switch set 9b is connected such that when switch set 9b is closed, terminals of the flying capacitor 8b are electrically connected across the terminals of the rail capacitor 10, and when the switch set 9b is open, the flying capacitor 8b is not electrically connected to the rail capacitor 10 and is electrically isolated from rail capacitor 10. Switch set 7b is connected such that when switch set 7b is closed, terminals of the flying capacitor 8b are electrically connected across the terminals of the power pack 2b, and when the switch set 7b is open, the flying capacitor 8b is not connected to the power pack 2b and is electrically isolated from power pack 2b.

Each of the switch sets 7a, 9a, 9b, and 7b may be controlled by control signals provided by, for example, control signal circuitry (not depicted). According to some example embodiments, each switch within the switch sets may be controllable by a respective control signal. The control signals are preferably configured to coordinate the operation of the switches to carry out balancing operations. The circuitry configured to generate and provide the control signals may be a processor executing code on a memory configured to generate and output the control signals, an application specific integrated circuit, an oscillator or other device configured to generate at least one periodic signal, or the like. Regardless of the manner in which the control signals are generated, the signals may be configured to permit charge to be shuttled by the rail capacitor between the flying capacitors to move charge from highly charged power packs to lower charged power packs as further described below.

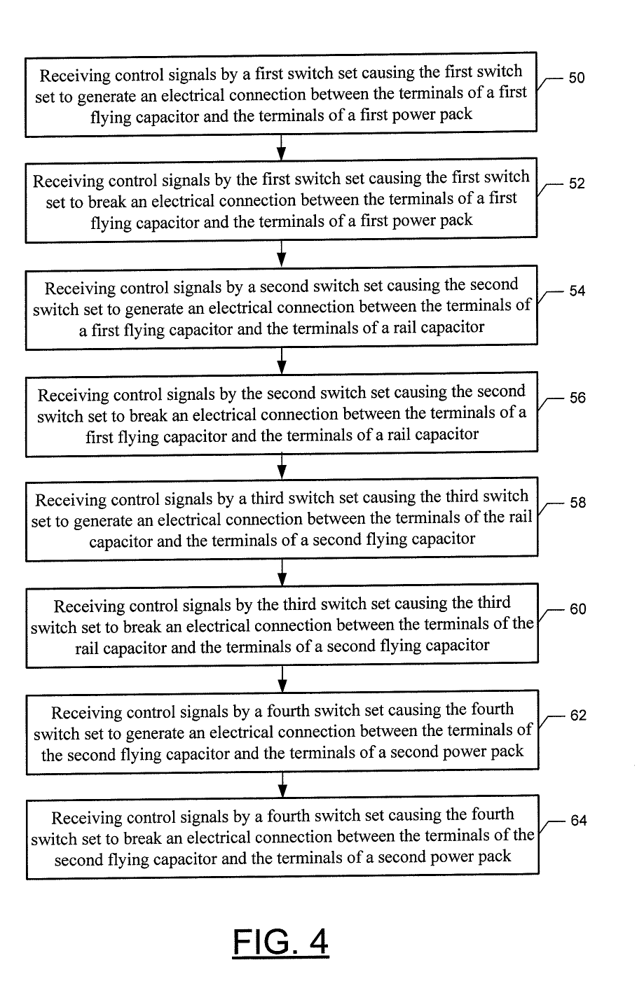

FIG. 4 illustrates an example method for performing power pack balancing that can be implemented, for example, by the power pack balancer 4 via control signals that cause operation of the switches 7a, 9a, 9b, and 7b. In this regard, at 50, control signals can be received by switch set 7a (first switch set) causing switch set 7a to generate an electrical connection between the terminals of flying capacitor 8a (first flying capacitor) and the terminals of the power pack 2a (first power pack) to charge or discharge the flying capacitor 8a across the terminals of the power pack 2a. At 52, control signals can be received by switch set 7a causing switch set 7a to break an electrical connection between the terminals of flying capacitor 8a and the terminals of the power pack 2a to discontinue charging or discharging of the flying capacitor 8a across the terminals of the power pack 2a.

At 54, control signals can be received by switch set 9a (second switch set) causing switch set 9a to generate an electrical connection between the terminals of the flying capacitor 8a and the terminals of the rail capacitor 10 to charge or discharge the flying capacitor 8a across the terminals of the rail capacitor 10. At 56, control signals can be received by switch set 9a causing switch set 9a to break an electrical connection between the terminals of the flying capacitor 8a and the terminals of the rail capacitor 10 to discontinue charging or discharging of the flying capacitor 8a across the terminals of the rail capacitor 10.

At 58, control signals can be received by switch set 9b (third switch set) causing switch set 9b to generate an electrical connection between the terminals of the flying capacitor 8b (second flying capacitor) and the terminals of the rail capacitor 10 to charge or discharge the flying capacitor 8b across the terminals of the rail capacitor 10. At 60, control signals can be received by switch set 9b causing switch set 9b to break an electrical connection between the terminals of the flying capacitor 8b and the terminals of the rail capacitor 10 to discontinue charging or discharging of the flying capacitor 8b across the terminals of the rail capacitor 10.

At 62, control signals can be received by switch set 7b (fourth switch set) causing switch set 7b to generate an electrical connection between the terminals of the flying capacitor 8b and the terminals of the power pack 2b (second power pack) to charge or discharge the flying capacitor 8b across the terminals of the power pack 2b. At 370, control signals can be received by switch set 7b causing switch set 7b to break an electrical connection between the terminals of the flying capacitor 8b and the terminals of the power pack 2b to discontinue charging or discharging the flying capacitor 8b across the terminals of the power pack 2b.

Via the example method of FIG. 4, energy can be moved from power pack 2a to power pack 2b to balance the energy between the power packs. These operations may be performed while the cell-level balancers of the power packs are also performing balancing between the parallel groups of cells within the respective power packs. According to some example embodiments, by reversing the order of operations of the example method of FIG. 4, energy can be moved from power 2b to power pack 2a. Further, according to some example embodiments, the operations 50 through 64 may be scaled to perform balancing between any number of power packs via use of the rail capacitor. According to some example embodiments, the control signals for controlling the switch sets 7a and 9a can be configured such that switch sets 7a and 9a are not simultaneously closed, to avoid electrically connecting the rail capacitor across the terminals of the power pack 2a. Similarly, according to some example embodiments, the control signals for controlling the switch sets 9b and 7b can be configured such that switch sets 9b and 7b are also not simultaneously closed.

Further, according to some example embodiments, the operation of a given switch of a particular switch set may be based on a frequency of a control signal for controlling that switch. Switches within a common set can be operated with a control signal having the same or similar frequency to facilitate simultaneous operation of the switches within the set, for example, in embodiments where the switches of a given set are separately controlled. Additionally, according to some example embodiments, the frequencies and waveforms of the control signals can be defined in a manner that avoids the simultaneous closure of switch set 7a with switch set 9a, or switch set 9b with switch set 7b.

According to some example embodiments, the frequency of operation of the switch sets can be increased or decreased to have different effects on the balancing of the power packs. For example, if the frequency is increased, the power packs of the energy system can be balanced more rapidly to achieve a lower average imbalance over a period of time. Increasing the frequency of balancing may be desired when an energy system is outputting high currents, which can tend to cause imbalance between the power packs at a relatively more rapid pace. On the other hand, for example, the frequency of operation may be decreased to slow the balancing of the power packs. Slowing the balancing operations may be utilized when then power storages system is outputting low current or no current, which can tend to cause imbalance between power packs at a relatively slower pace. Decreasing the frequency during low or no current output can also result in power savings by reducing the energy used for balancing operations. According to some example embodiments, an ammeter or other current sensing device can be included in an example balancing apparatus that measures the output current for the power system, and modifies the frequency of operation of the switches based on the measured output current.

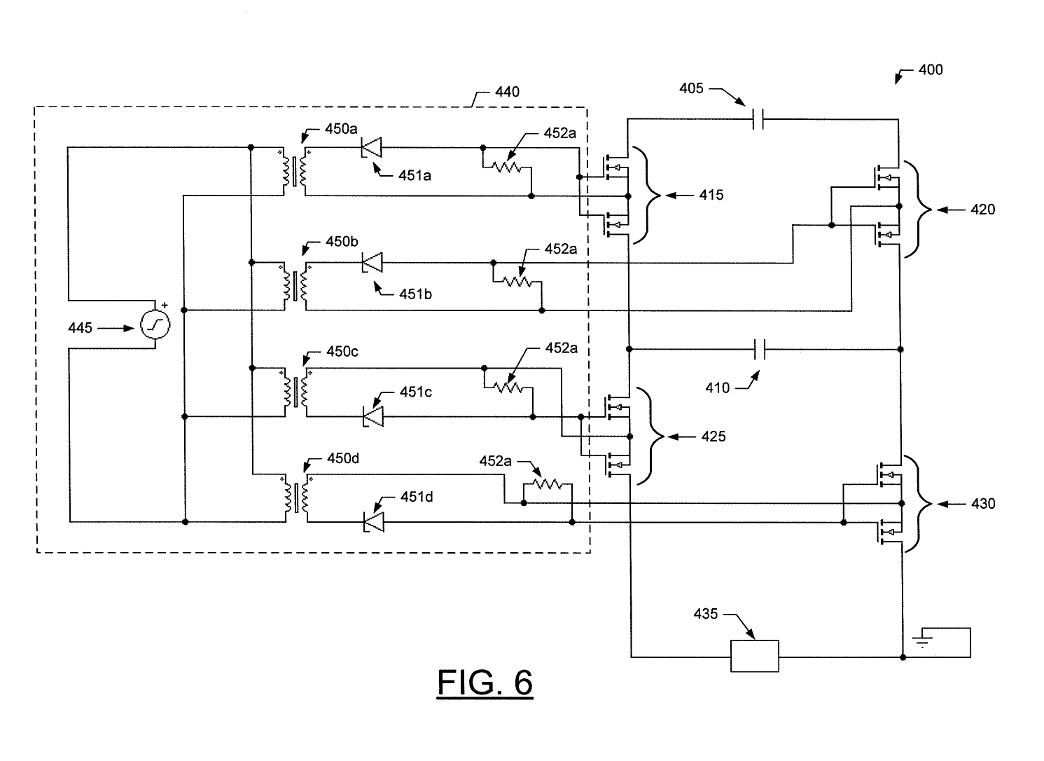

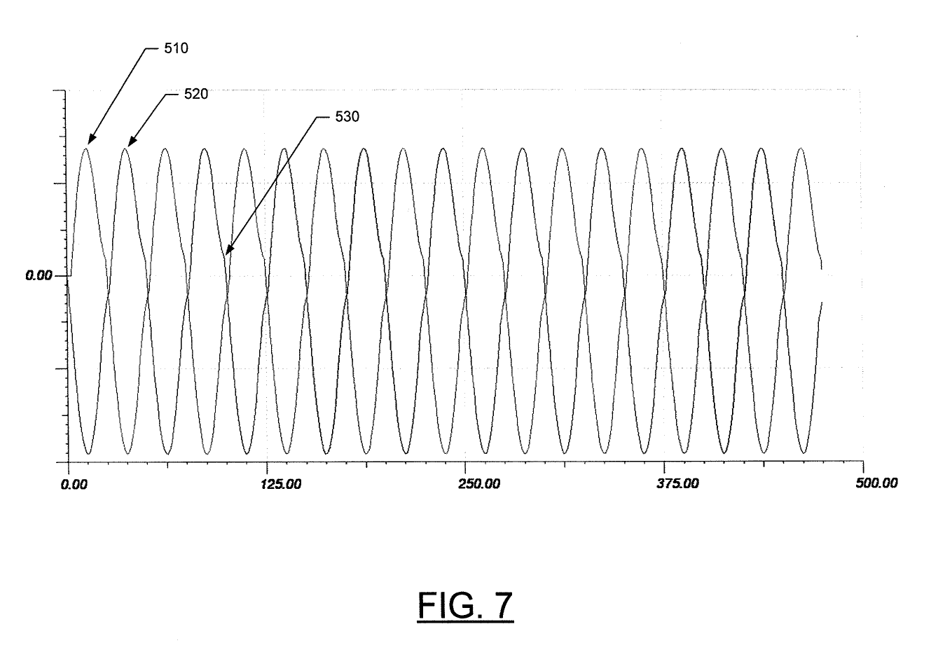

FIG. 6 illustrates another example power pack balancer 400 that uses impedance balancing according to various example embodiments of the present invention. In comparison to FIG. 3, the balancer 400 includes switches and a flying capacitor for interacting with a single power pack 435 for illustration purposes. However, based on the description of FIG. 3, the concepts described with respect to FIG. 6 can be scaled for interaction with any number of power packs to perform balancing between power packs, while the power packs perform balancing of cells via respective cell-level balancers. In this regard, power pack 435 includes a cell-level balancer (not depicted) that operates in the same manner as described with respect to cell-level balancers 3a and 3b.

The balancer 400 of FIG. 6 includes a rail capacitor 405, a flying capacitor 410, switches 415, 420, 425, and 430, and control signal circuitry 440. The rail capacitor 405 is switchably connected to the flying capacitor 410 via the switches 415 and 420. The flying capacitor 410 is switchably connected to the power pack 435 via switches 425 and 430. As such, referencing FIG. 3, the switches 425 and 430 can correlate to the switch set 7a and switches 415 and 420 can correlate to the switch set 9a. While each of switches 415, 420, 425, 430 comprise two field-effect transistors (FETs) that are source-source connected and share a common gate terminal connection to the control signal circuitry 440, it is contemplated that any type of switching device, such as those described above with respect to switches 7a, 7b, 9a, and 9b may be employed. In this configuration as provided in FIG. 6, the two FETs can operate as a single switch that can be controlled via a signal applied to the common gate connection.

The control signal circuitry 440 is preferably configured to generate a control signal for each of the switches 415, 420, 425, and 430, in accordance with various example embodiments. The signals generated by the control signal circuitry 440 can be configured to drive the gate terminals of the FETs or otherwise control the switches. In this regard, each FET can be configured to generate a conductive channel (close the switch or generate an electrical connection) when a voltage applied to the gate terminal is a particular value. For example, the FETs can be configured to generate a conductive channel when the voltage applied to the gate terminal exceeds a gate threshold voltage. As such, if, for example, a sine wave is applied to the gate terminal of a FET, the FET can generate a conductive channel during the portion of the sine wave when the gate threshold voltage is exceeded. When the voltage of the sine wave falls below the gate threshold voltage, no conductive channel is formed (switch is open or break an electrical connection). Switching devices and components can also be used which have similar threshold level switching characteristics.

As described above, the order in which the switches 415, 420, 425, and 430 are operated to generate and break electrical connections as part of an impedance balancing operation can be configured to prevent switches 425 and 430 from being closed at the same time as switches 415 and 420. To do so, according to some example embodiments, a waveform that is received by switches 415 and 420 can be inverted or shifted 180 degrees and provided to the respective gate terminals of the FETs. In some example embodiments, an inverted or 180 degree shifted version of the same waveform can be generated by connecting opposite polarities for the control signals to switches 415 and 420 relative to the polarity used for switches 425 and 430.

The control signal circuitry 440 of FIG. 6 provides one example of an apparatus for generating control signals for the switches. The control signal circuitry can comprise a signal generator 445, transformers 450 (e.g., transformers 450a, 450b, 450c, and 450d), diodes 451 (e.g., diodes 451a, 451b, 451c, 451d), and resistors 452 (e.g., resistors 452a, 452b, 452c, and 452d). The signal generator 445 can be any type of device configured to generate a dynamically changing signal (e.g., an alternating current signal). According to some example embodiments, the signal produced by the signal generator can take the form of a sign wave, a sawtooth, a step function, or the like.

A first terminal of the signal generator 445 can be electrically connected to a respective first primary winding terminal of each of the transformers 450, and a second terminal of the signal generator 445 can be connected to a respective second primary winding terminal of each of the transformers 450. The transformers 450 and the winding ratios of the transformers 450 may be selected based on, for example, the gate threshold voltage of the FETs or switching devices and the rate of change in the voltage of the signal generator. Additionally, the gate terminal of the FETs can have an internal capacitance, which the transformers 450 can be configured to store sufficient energy to exceed any energy that may be stored in the gate's internal capacitance. In this regard, the transformers can be configured to store sufficient energy to cause the FETs to generate a conductive channel. According to some example embodiments, the transformers 450 may be pulse transformers.

Additionally, the secondary terminals of the transformers can be connected to the gates of the FETs such that the polarity that is used in the connections to switches 415 and 420 is opposite to the polarity used in the connections to the switches 425 and 430. In this manner, the gate terminals of the FETs for switches 415 and 420 can receive an inverted signal relative to the signal received at the gate terminals of the FETs for switches 425 and 430.

Some example embodiments may include the resistors 452 and diodes 451, however, in some example embodiments, an impedance balancer may be constructed without the resistors 452 and diodes 451. The resistors 452 connected across the secondary terminals of the transformers 450 can operate to form a circuit current path with a current limiting voltage drop. The diodes 451 can be Zener diodes connected between the transformer terminal and the gate terminals of the FETs in a manner that impacts the waveform output by the transformer terminals to create a gap between the latest opening of a first set of switches and the earliest closing of a second set of switches. In this manner, the waveform driving the gates can be asymmetric around zero volts. In this regard, the internal capacitance of the gates of the FETs, or a shunt capacitor connected across the secondary terminals of the transformer, can discharge through the diode when, for example, a sinusoidal waveform is falling below the voltage of the charged internal capacitances of the shunt capacitor. This discharging through the diode can have the effect of flattening a portion of the waveform as the voltage of the waveform drops through, for example, zero volts.

FIG. 7 is a graph of the resultant waveforms that are received at the gates terminals of the FETs in FIG. 6, given a sinusoidal source signal. The waveform 510 can drive the gate terminals of, for example, switches 415 and 420, and the waveform 520 can drive the gate terminals of, for example, switches 425 and 430. Due to the presence of a diode in the gate terminal circuit, waveforms 510 and 520 flatten, for example, at 530. This flattening as the voltage decreases creates a durational gap between the waveforms 510 and 520 at zero volts and the waveforms cross below zero volts. As a result, assuming the gate threshold voltages are a positive voltage for the FETs, switches 415 and 420 will not be generating an electrical connection at the same time as switches 425 and 430.

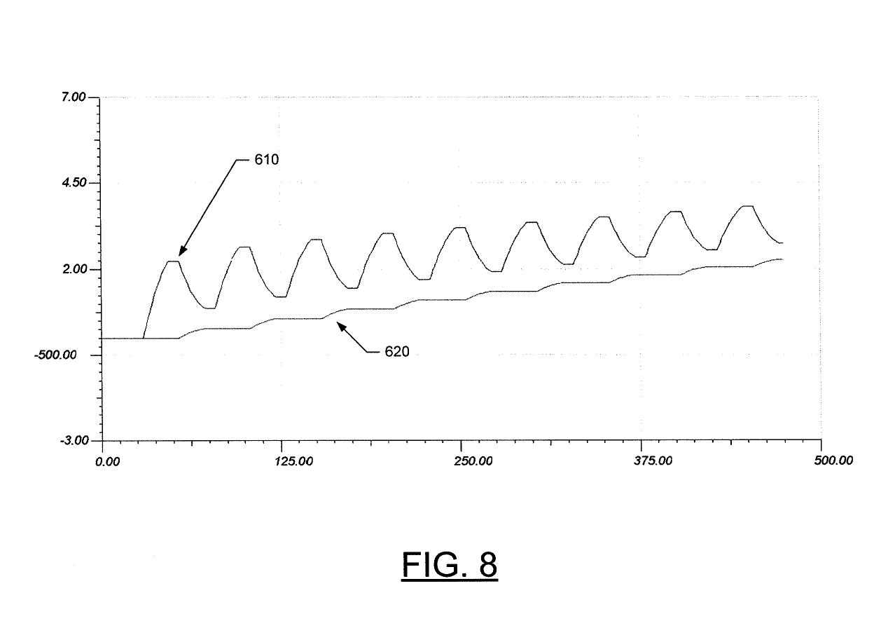

FIG. 8 is a graph 610 of flying capacitor 410 being charged across the power pack 435 based on the control signals of FIG. 8, and a graph 620 of the charging of the rail capacitor 405 via the flying capacitor 410 based on the control signal of FIG. 8. The clipped peaks and valleys of the flying capacitor charging graph 610 are a result of the durational gap when switches 415, 420, 425, and 430 are all open to facilitate a break-before-make transition from the flying capacitor 410 being connected to the power pack 435 and then to the rail capacitor 405. The flying capacitor voltage in graph 610 also indicates that the power cell voltage is slowly increasing during the process depicted in FIG. 6. The rail capacitor charge graph 620 shows that when the flying capacitor 410 is discharging, the rail capacitor 405 is being charged by the flying capacitor 410. It is noteworthy that the graph 620 shows the rail capacitor continuing to increase in charge. However, if the rail capacitor 405 were switchably connected to additional flying capacitors and associated power cells according to various example embodiments, the rail capacitor could be discharging to the other flying capacitors, thereby dropping the charge storage level of the rail capacitor.

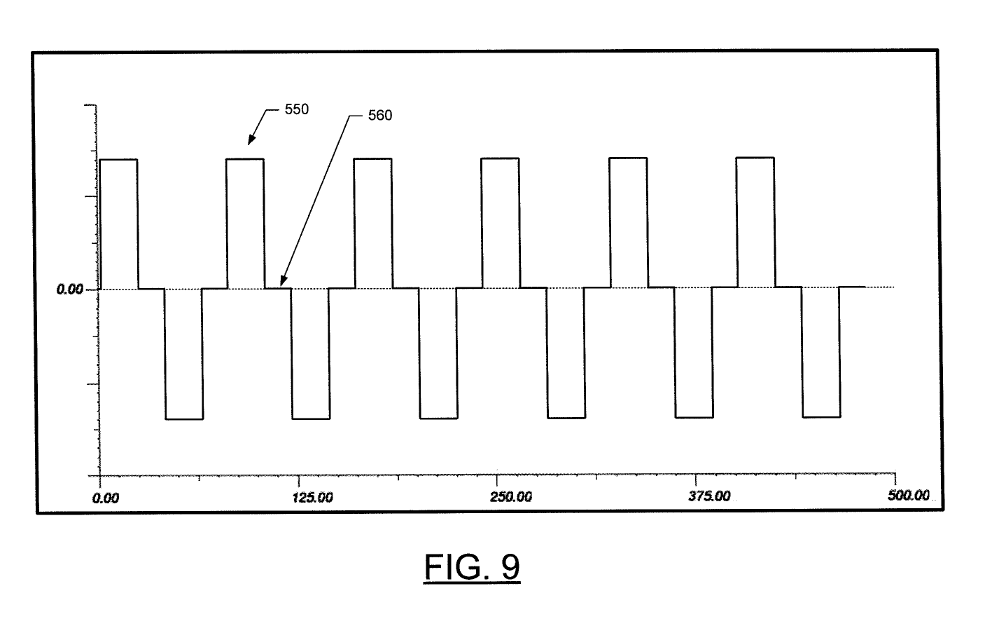

FIG. 9 illustrates a graph of an alternative control signal 550 that may be provided to switching devices, such as the gate terminals of, for example, the FETs in FIG. 6. In this regard, control signal 550 may be provided to the gate terminals of switches 415 and 420, and the inversion of control signal 550 may be provided to the get terminals of the switches 425 and 430. The waveform 550 is defined as a 3 level step function, where, within each cycle the waveform include a period of time at a high level, a period at a zero level 560, and a period at a low level. The period at the zero level 560 may be configured such that the duration is sufficient to ensure that, for example, switches 415 and 420 are not closed at the same time as switches 425 and 430. According to some example embodiments, the waveform 550 and the inversion of the waveform 550 may be provided directly to the gate terminals of the respective switches by, for example, a signal generator configured to generate the waveform 550. In this regard, according to some example embodiments, the signal generator may include outputs where a first polarity of the outputs is connected to the gate terminals of 415 and 420 and as second and opposite polarity is connected to the gate terminals of the switches 425 and 430.

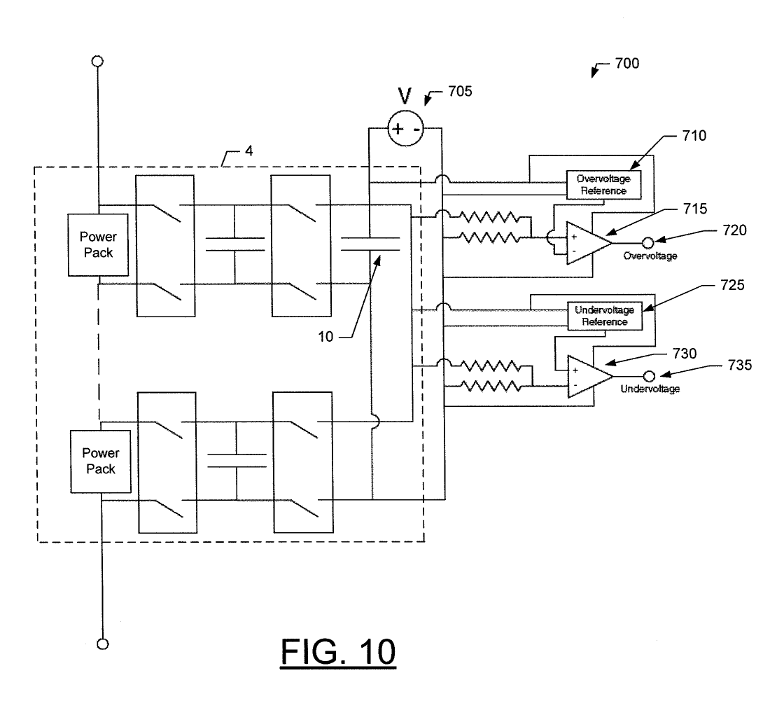

FIG. 10 illustrates an energy system monitor 700 connected to the power pack balancer 4 of FIG. 3. The energy system monitor 700 can be comprised of monitoring circuitry configured to monitor the voltage across the terminals of the rail capacitor 10, and use an indication of the voltage as an aggregate status indicator for the power cells of the energy system. In this regard, the monitoring circuitry can receive an indication of a voltage across the rail capacitor terminals and provide a status indicator for an energy system based on the received indication. According to various example embodiments, an indication of the rail capacitor voltage can be analyzed, for example, by a processor or analog systems and detailed information, for example the actual voltage value, may be output to a display of a user interface and used as an indication of an energy system status. In some example embodiments, reference voltages for undervoltage and overvoltage conditions can be defined, and the voltage of the rail capacitor can be compared to the references. In this regard, the monitoring circuitry can be configured to compare an indication of a voltage across the rail capacitor terminals to an overvoltage reference to determine an overvoltage status of an energy system, and compare an indication of a voltage across the rail capacitor terminals to an undervoltage reference to determine an undervoltage status of the energy system. If an overvoltage condition is identified, then, for example, an overvoltage light emitting diode (LED) can be lit. Similarly, if an undervoltage condition is identified, then, for example, and undervoltage LED can be lit.

According to some example embodiments, an energy system monitor may be configured to consider the current aggregate average voltage of the parallel groups as indicated by the voltage across the rail capacitor, the current that the entire energy system is currently sinking or sourcing, and the impedance of the entire energy system (e.g., the entire system's dV/dI). Based on a map of a characteristic discharge curve for the given chemistry of the power cells (e.g., a map or graph of the resting voltage versus the percentage of energy extracted, or resting voltage versus the Joules in or out), the local impedance (dV/dI), and a quality estimate of the average voltage of the parallel groups making up the system (e.g., the voltage observed at the rail capacitor), Ohm's law can be used to determine a position in a “resting voltage” characteristic discharge curve. In some example embodiments, the characteristic discharge curve can be dynamically determined based on historical system data.

With the use of, for example, a processor, a voltage sensor, and a current sensor, the relationship between voltage and current can be determined and updated based on recently collected data points for voltage and current. The impedance date for the system can be derived from the voltage/current relationship. In this regard, a voltage sensor on the rail capacitor can provide the input voltage (Vrail), and a current sensor on the energy system output can provide the output current (Iout). A memory, for example a volatile memory, can store the discharge curve shape and the equation to calculate the resting voltage, which is Vrest=Vrail+Iout*Rsystem. With an analog system, a variable gain amplifier and operational amplifiers (opamp) of fixed gain can be utilized to determine the result. In this regard, the first opamp can buffer the measured rail capacitor voltage, and the second opamp can scale the current sensor data. A third opamp can take the differential of the output of the first and second opamps and provides the resting voltage estimate. The voltage signal from the current sensor can be multiplied via the variable gain amplifier, where the gain is the value of Rsystem which can be derived from an analog differentiator circuit.

Both a processor-based or analog component-based system can thus accurately provide a State of Charge within the characteristic discharge curve. This can be performed in realtime from direct measurements and a buffer of recent historic operational data points to derive the impedance and the discharge curve. The energy management system monitor may also consider impedance of the system as an indication of system health. Additionally, or alternatively, changes in the shape and position of the characteristic discharge curve can be used as indications of system health. The State of Charge, as well as the other measured and determined values may be output to a user interface (e.g., light emitting diodes, a display, or the like) or used as inputs to another system that may stores the values as data or perform further analysis.

An additional or alternative measure of energy system health can be based on the current (e.g., RMS current) that is flowing into or out of a flying capacitor between the flying capacitor and the cell or parallel group of cells, or between the flying capacitor and the rail capacitor. In a balanced system this current would be relatively small or zero. Relatively higher currents for a flying capacitor can indicate whether the associated cell or parallel group of cells is strong or weak. The values provided by current sensors connected to the flying capacitors may provide inputs to a user interface, such as a respective LEDs where the brightness of the LEDs can indicate the relative health of the associated cell or parallel group. Additionally, or alternatively, the current sensors may provide inputs to a processor that can, for example, further aggregate and analyze the values, provide indications of the values to a display, or store the values for historical analysis.

As such, the operation of the rail capacitor within a impedance balancer can also be leveraged for the purpose of also providing information about the overall health of the cells of the energy system. By monitoring the rail capacitor in this way, according to some example embodiments, only one voltage monitor is utilized for the entire energy system, thereby reducing cost and complexity.

The energy system monitor 700 can utilize the voltage across the rail capacitor to provide a status indicator for an energy system. The energy management system monitor 700 includes an overvoltage reference 710, an overvoltage comparator 715, an overvoltage status output 720, an undervoltage reference 725, an undervoltage comparator 730, and an undervoltage status output 735.

The overvoltage reference 710 and the undervoltage reference 725 can be variable resistors, precision voltage sources, bandgap references, or other mechanisms for establishing a desired reference voltage based on the voltage provided by the reference voltage source 705. The outputs of the overvoltage reference and the undervoltage reference can be fed into the inputs of respective comparators 715 and 730. The comparators 715 and 730 can also receive an indication of the voltage across the rail capacitor 230, for example, via a resistor network. The overvoltage comparator 715 can be configured to determine if the indication of the voltage across the rail capacitor 10 is greater than the voltage provided by the overvoltage reference 710. If the indication of the voltage across the rail capacitor 10 is greater than the reference voltage, then the overvoltage status output 720 can indicate a “true” output (e.g., provide a high voltage level). If the indication of the voltage across the rail capacitor 10 is less than the reference voltage, then the overvoltage status output 720 can indicate a “false” output (e.g., provide a low voltage level). Similarly, the undervoltage comparator 730 can be configured to determine if the indication of the voltage across the rail capacitor 10 is less than the voltage provided by the undervoltage reference 725. If the indication of the voltage across the rail capacitor 10 is less than the reference voltage, then the undervoltage status output 735 can indicate a “true” output (e.g., provide a high voltage level). If the indication of the voltage across the rail capacitor 10 is less than the reference voltage, then the overvoltage status output 735 can indicate a “false” output (e.g., provide a low voltage level).

An energy management system monitor, such as, for example, the energy system monitor 700, can be configured to operate while the energy system is supplying a load, being charged, or is dormant. Further, an energy system monitor 700 can be configured to operate during balancing operations, such as, for example, the balancing operation described with respect to FIG. 4. In this regard, according to some example embodiments, the example method of FIG. 4 can further include receiving an indication of a voltage across the terminals of the rail capacitor, and providing a status indicator for an energy system based on the received indication. In some example embodiments, the example method of FIG. 4 can, additionally or alternatively, include comparing an indication of a voltage across the terminals of the rail capacitor to an overvoltage reference to determine an overvoltage status of an energy system, and comparing an indication of a voltage across the terminals of the rail terminals to an undervoltage reference to determine an undervoltage status of the energy system.

Additionally, according to some example embodiments, the rail capacitor can also be leveraged for charging purposes. In this regard, the voltage source 705 can be a charging apparatus that is connected across the terminals of the rail capacitor 10. The voltage source 705 can charge the rail capacitor to a desired level and, through use of the same switch operation scheme used for balancing, the rail capacitor 10 can perform charging. In some respects, the impedance balancing apparatus can treat the voltage source 705 as another cell or parallel group of cells for balancing. However, since the voltage source 705 is an entry point for energy into the system, the rail capacitor 10 would continuously be charged by the voltage source 705, until the voltage source 705 is removed from the circuit as the charger.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A hierarchical balancer apparatus comprising:
a rail capacitor comprising rail capacitor terminals;
a first capacitor comprising first capacitor terminals, wherein the first capacitor terminals are switchably connected across terminals of a first power pack via a first set of controllable switches, and wherein the first capacitor terminals are also switchably connected across the rail capacitor terminals via a second set of controllable switches, wherein the first power pack includes a first cell-level balancer apparatus that is configured to balance charge between power cells of the first power pack;
a second capacitor comprising second capacitor terminals, wherein the second capacitor terminals are switchably connected across the rail capacitor terminals via a third set of controllable switches, and wherein the second capacitor terminals are also switchably connected across terminals of a second power pack via a fourth set of controllable switches, wherein the second power pack includes a second cell-level balancer apparatus that is configured to balance charge between power cells of the second power pack.

2. The hierarchical balancer apparatus of claim 1 further comprising control signal circuitry configured to provide respective control signals to the first, second, third and forth sets of controllable switches and control the first, second, third and forth sets of controllable switches to perform a balancing operation between the first power pack and the second power pack.

3. The hierarchical balancer apparatus of claim 1 further comprising voltage monitoring circuitry configured to:
receive an indication of a voltage across the rail capacitor terminals; and
provide a status indicator for an energy system based on the received indication.

4. The hierarchical balancer apparatus of claim 1 further comprising voltage monitoring circuitry configured to:
compare an indication of a voltage across the rail capacitor terminals to an overvoltage reference to determine an overvoltage status of an energy system; and
compare an indication of a voltage across the rail capacitor terminals to an undervoltage reference to determine an undervoltage status of the energy system.

5. The hierarchical balancer apparatus of claim 1, wherein the first power pack is electrically connected in parallel with at least a third power pack;
wherein the second power pack is electrically connected in parallel with at least a fourth power pack;
wherein the third power pack includes a third cell-level balancer apparatus that is configured to balance charge between power cells of the third power pack; and
wherein the fourth power pack includes a fourth cell-level balancer apparatus that is configured to balance charge between power cells of the fourth power pack.

6. The hierarchical balancer apparatus of claim 1 further comprising control signal circuitry configured to provide respective control signals to each switch within the first and second sets of controllable switches, wherein the respective control signals are configured to:
cause the first set of controllable switches to generate an electrical connection between the first capacitor terminals and the terminals of the first power pack to charge or discharge the first capacitor across the terminals of the first power pack; and
cause the second set of controllable switches to generate an electrical connection between the first capacitor terminals and the rail capacitor terminals to charge or discharge the first capacitor across the terminals of the rail capacitor.

7. The hierarchical balancer apparatus of claim 1 further comprising control signal circuitry configured to provide a first set of control signals to the second set of controllable switches and a second set of control signals to the third set of controllable switches;
wherein the first set of control signals cause the second set of controllable switches to generate and break an electrical connection between the first capacitor terminals and the rail capacitor terminals based on a frequency of the first set of control signals; and
wherein the second set of control signals cause the third set of controllable switches to generate and break an electrical connection between the rail capacitor terminals and the second capacitor terminals based on a frequency of the second set of control signals.

8. The hierarchical balancer apparatus of claim 1 further comprising control signal circuitry configured to provide a first set of control signals to the first set of controllable switches and a second set of control signals to the second set of controllable switches, wherein respective frequencies of the first set of control signals and the second set of control signals are based on an output current of an energy system comprising the first power pack and the second power pack.

9. The hierarchical balancer apparatus of claim 1 further comprising control signal circuitry configured to provide respective control signals to each of the switches within the first, second, third, and forth sets of controllable switches, wherein the respective control signals are configured to:
cause the first set of controllable switches to generate an electrical connection between the first capacitor terminals and the terminals of the first power pack to charge or discharge the first capacitor across the terminals of the first power pack;
cause the second set of controllable switches to generate an electrical connection between the first capacitor terminals and the rail capacitor terminals to charge or discharge the first capacitor across the terminals of the rail capacitor;
cause the third set of controllable switches to generate an electrical connection between the rail capacitor terminals and the second capacitor terminals to charge or discharge the second capacitor across the rail capacitor terminals; and
cause the fourth set of controllable switches to generate an electrical connection between the second capacitor terminals and the terminals of the second power pack to charge or discharge the second capacitor across the terminals of the second power pack;
wherein the first and fourth sets of controllable switches do not generate electrical connections simultaneously.

10. The hierarchical balancer apparatus of claim 1 further comprising control signal circuitry configured to provide respective control signals to each of the switches within the first, second, third, and forth sets of controllable switches, wherein the respective control signals are configured to control the second and third sets of controllable switches to prevent the rail capacitor terminals from being electrically connected to the first capacitor terminals and the second capacitor terminals simultaneously.

11. The hierarchical balancer apparatus of claim 1 further comprising control signal circuitry configured to provide respective control signals to each of the switches within the first, second, third, and forth sets of controllable switches to perform a charge balancing operation between the first power pack and the second power pack independent of cell-level balancing operations performed by the first cell-level balancer apparatus and the second cell-level balancer apparatus.

12. A method for hierarchical balancing, the method comprising:
generating a first electrical connection between terminals of a first capacitor and terminals of a first power pack to charge or discharge the first capacitor across the terminals of the first power pack;
generating a second electrical connection between the terminals of the first capacitor and terminals of a rail capacitor to charge or discharge the first capacitor across the terminals of the rail capacitor;
generating a third electrical connection between the terminals of the rail capacitor and terminals of a second capacitor to charge or discharge the second capacitor across the rail capacitor terminals;
generating a fourth electrical connection between the terminals of the second capacitor and terminals of a second power pack to charge or discharge the second capacitor across terminals of a second power cell;
wherein during the generating of the first, second, third or fourth electrical connections, a first cell-level balancer apparatus of the first power pack balances charge between power cells of the first power pack and a second cell-level balancer apparatus of the second power pack balances charge between power cells of the second power pack.

13. The method of claim 12 further comprising:
receiving control signals at a first set of controllable switches to generate the electrical connection between the terminals of the first capacitor and the terminals of the first power pack;
receiving control signals at a second set of controllable switches to generate the electrical connection between the terminals of the first capacitor and the terminals of a rail capacitor;
receiving control signals at a third set of controllable switches to generate the electrical connection between the terminals of the rail capacitor and the terminals of the second capacitor; and
receiving control signals at a fourth set of controllable switches to generate the electrical connection between the terminals of the second capacitor and the terminals of the second power pack.

14. The method of claim 12 further comprising:
receiving an indication of a voltage across the terminals of the rail capacitor; and
providing a status indicator for an energy system based on the received indication.

15. The method of claim 12 further comprising:
comparing an indication of a voltage across the terminals of the rail capacitor to an overvoltage reference to determine an overvoltage status of an energy system; and
comparing an indication of a voltage across the terminals of the rail terminals to an undervoltage reference to determine an undervoltage status of the energy system.

16. The method of claim 12, wherein the first power pack is electrically connected in parallel with at least a third power pack;
wherein the second power pack is electrically connected in parallel with at least a fourth power pack;
wherein the third power pack includes a third cell-level balancer apparatus that is configured to balance charge between power cells of the third power pack; and
wherein the fourth power pack includes a fourth cell-level balancer apparatus that is configured to balance charge between power cells of the fourth power pack.

17. The method of claim 12, further comprising:
generating and breaking the electrical connection between the terminals of the first capacitor and terminals of a rail capacitor based on a frequency of a first set of control signals; and
generating and breaking the electrical connection between the terminals of the rail capacitor and the terminals of a second capacitor based on a frequency of a second set of signals;
wherein the first set of control signals and second set of control signal are further configured to prevent the rail capacitor terminals from being electrically connected to the first capacitor terminals and the second capacitor terminals simultaneously.

18. The method of claim 12, further comprising:
generating and breaking the electrical connection between the terminals of the first capacitor and terminals of a rail capacitor based on a frequency of a first set of control signals; and
generating and breaking the electrical connection between the terminals of the rail capacitor and the terminals of a second capacitor based on a frequency of a second set of signals;
wherein respective frequencies of the first set of control signals and the second set of control signals are based on an output current of an energy system comprising the first power pack and the second power pack.

19. The method of claim 12, receiving control signals at each of the switches within the first, second, third, and forth sets of controllable switches to perform a charge balancing operation between the first power pack and the second power pack independent of cell-level balancing operations performed by the first cell-level balancer apparatus and the second cell-level balancer apparatus.

20. An energy system monitor comprising circuitry configured to measure a voltage across a rail capacitor and output a status indication based on the measured voltage, wherein the rail capacitor is switchably connected to a first capacitor and switchably connected to a second capacitor, and wherein the first capacitor is also switchably connected to a first power pack and the second capacitor is also switchably connected to a second power pack; wherein the first power pack includes a first cell-level balancer apparatus that is configured to balance charge between power cells of the first power pack and the second power pack includes a second cell-level balancer apparatus that is configured to balance charge between power cells of the second power pack.

21. The energy system monitor of claim 20, wherein the circuitry configured to output the status indication includes being configured to output a plurality of status indications by comparing the measured voltage to a respective plurality of reference voltages.
